(19) United States
(12) Patent Application Publication
(10) Pub. No.: US 2024/0249012 A1
(43) Pub. Date: Jul. 25, 2024

(54) SYSTEMS AND METHODS FOR DETECTION OF TOXIC ACCESS COMBINATIONS

(71) Applicant: JPMORGAN CHASE BANK, N.A., New York, NY (US)

(72) Inventors: Gaurav GAYAWAR, Bengaluru (IN); Alok SINGH, Bangalore (IN); Smitha GANESH, Bangalore (IN); Matthew JAVANSHIR, Southampton (GB); Timothy RADEBAUGH, Jr., Lewis Center, OH (US); Avisa SHERRELL, Scarsdale, OH (US)

(21) Appl. No.: 18/419,228

(22) Filed: Jan. 22, 2024

(30) Foreign Application Priority Data
Jan. 25, 2023 (IN) 202311004968

(51) Int. Cl. G06F 21/62; G06F 16/33

(52) U.S. Cl. CPC G06F 21/6218; G06F 16/3347; G06F 2221/2113; G06F 2221/2141

(57) ABSTRACT

In some aspects, the techniques described herein relate to a method including: storing, in an application management database, an audit group, wherein the audit group identifies one or more computer applications; querying the application management database, wherein the querying returns a plurality of access control descriptions from the application management database; processing keywords from the plurality of access control descriptions with a machine learning (ML) model to determine a plurality of duty groups; associating access control permissions with the plurality of duty groups based on the keywords; and determining toxic combinations of the access control permissions based on database relationships between the plurality of duty groups, the audit group, and a user identifier.

### RELATED APPLICATIONS

This application claims priority to, and the benefit of, Indian Patent Application No. 202311004968, filed Jan. 25, 2023, the disclosure of which is hereby incorporated, by reference, in its entirety.

### BACKGROUND

### 1. Field of The Invention

Aspects generally relate to systems and methods for detection of toxic access combinations.

### 2. Description of the Related Art

Toxic system access combinations are access control permission combinations to an organization's operational systems, such as technological systems, computer applications, etc., which, if possessed by an individual, would provide the individual the opportunity to circumvent organizational controls. Currently, business relies on an auditor's understanding of the business process being audited in addition to an understanding of the access control systems and access entitlements utilized by the technology in scope. As organizations scale and technology infrastructures become more complex and intertwined, however, this approach becomes ever more susceptible to human error and oversight.

### SUMMARY

In some aspects, the techniques described herein relate to a method including: storing, in an application management database, an audit group, wherein the audit group identifies one or more computer applications; querying the application management database, wherein the querying returns a plurality of access control descriptions from the application management database; processing keywords from the plurality of access control descriptions with a machine learning (ML) model to determine a plurality of duty groups; associating access control permissions with the plurality of duty groups based on the keywords; and determining toxic combinations of the access control permissions based on database relationships between the plurality of duty groups, the audit group, and a user identifier.

In some aspects, the techniques described herein relate to a method, wherein the audit group includes a plurality of computer applications.

In some aspects, the techniques described herein relate to a method, wherein the plurality of computer applications are included in an organizational process.

In some aspects, the techniques described herein relate to a method, including: parsing the plurality of access control descriptions for dependencies.

In some aspects, the techniques described herein relate to a method, including: determining parts of speech in the plurality of access control descriptions using a natural language processing (NLP) model.

In some aspects, the techniques described herein relate to a method, wherein the dependencies are based on the parts of speech.

In some aspects, the techniques described herein relate to a method, including: generating vector embeddings from the keywords.

In some aspects, the techniques described herein relate to a system including at least one computer including a processor and a memory, wherein the at least one computer is configured to: store, in an application management database, an audit group, wherein the audit group identifies one or more computer applications; query the application management database, wherein the querying returns a plurality of access control descriptions from the application management database; process keywords from the plurality of access control descriptions with a machine learning (ML) model to determine a plurality of duty groups; associate access control permissions with the plurality of duty groups based on the keywords; and determine toxic combinations of the access control permissions based on database relationships between the plurality of duty groups, the audit group, and a user identifier.

In some aspects, the techniques described herein relate to a system, wherein the audit group includes a plurality of computer applications.

In some aspects, the techniques described herein relate to a system, wherein the plurality of computer applications are included in an organizational process.

In some aspects, the techniques described herein relate to a system, including: parsing the plurality of access control descriptions for dependencies.

In some aspects, the techniques described herein relate to a system, including: determining parts of speech in the plurality of access control descriptions using a natural language processing (NLP) model.

In some aspects, the techniques described herein relate to a system, wherein the dependencies are based on the parts of speech.

In some aspects, the techniques described herein relate to a system, including: generating vector embeddings from the keywords.

In some aspects, the techniques described herein relate to a non-transitory computer readable storage medium, including instructions stored thereon, which instructions, when read and executed by one or more computer processors, cause the one or more computer processors to perform steps including: storing, in an application management database, an audit group, wherein the audit group identifies one or more computer applications; querying the application management database, wherein the querying returns a plurality of access control descriptions from the application management database; processing keywords from the plurality of access control descriptions with a machine learning (ML) model to determine a plurality of duty groups; associating access control permissions with the plurality of duty groups based on the keywords; and determining toxic combinations of the access control permissions based on database relationships between the plurality of duty groups, the audit group, and a user identifier.

In some aspects, the techniques described herein relate to a non-transitory computer readable storage medium, wherein the audit group includes a plurality of computer applications.

In some aspects, the techniques described herein relate to a non-transitory computer readable storage medium, wherein the plurality of computer applications are included in an organizational process.

In some aspects, the techniques described herein relate to a non-transitory computer readable storage medium, including: parsing the plurality of access control descriptions for dependencies.

In some aspects, the techniques described herein relate to a non-transitory computer readable storage medium, including: determining parts of speech in the plurality of access control descriptions using a natural language processing (NLP) model.

In some aspects, the techniques described herein relate to a non-transitory computer readable storage medium, wherein the dependencies are based on the parts of speech and including: generating vector embeddings from the keywords.

### BRIEF DESCRIPTION OF THE DRAWINGS

FIG. 1 depicts a block diagram of a system for detection of toxic access combinations, in accordance with aspects.

FIG. 2 depicts a logical flow for determining toxic access combinations, in accordance with aspects.

FIG. 3 depicts a block diagram of a technology infrastructure and computing device for implementing certain aspects of the present disclosure, in accordance with aspects.

FIG. 4 depicts a logical flow for detection of toxic access combinations, in accordance with aspects.

### DETAILED DESCRIPTION

Aspects generally relate to systems and methods for detection of toxic access combinations.

In accordance with aspects, natural language processing models and machine learning (ML) training algorithms and modeling may be used to detect toxic access combinations. Toxic system access combinations are access control permission combinations to an organization's technological systems, including computer applications, which, if possessed by an end user, would provide the end user the opportunity to circumvent organizational controls with respect to a computer application for which the access combinations are provided.

Access control permissions provide a user account associated with an end user of a computer application with different levels of access to view and manipulate data from within the computer application. Various levels of access control permissions can be granted to end users. Exemplary access control permissions include access based on the create, read, update, delete (CRUD) access permissions that are often associated with database and file directory operations. More fine-grained access permissions can be found in many environments, however, that allow user access to be more finely tuned. Additional access control permissions may include “modify,” “write,” “execute,” etc., and may allow system administrators to provide a more granular access to applications. Moreover, the application may provide custom access control functionality. For example, an invoice management application may include an “approval” access control that allows users that have been granted the approval control to approve submitted invoices. The invoice management application may further have a “submit” access control that allows users granted submit access to submit an invoice.

With reference to an exemplary invoice management application, a user having both submit and approval access to the application may be considered to have a toxic access combination. This is because such a user would be able to both submit and approve an invoice. The ability to both submit and approve an invoice allows for the possibility of fraudulent activity, and accordingly would be considered a liability in many organizations. Toxic access combinations may be difficult to manually identify given the high number of access levels, the ubiquity of applications in an organization, and large numbers of end users, each of which may have varying business needs and justifications for access a given application.

In accordance with aspects, organizations may maintain an application management database of computer applications in use on the organization's technology infrastructure. Such a database may include a set of access control permissions that may be assigned to a user of an application. Both a user of an application and an application may have or be associated with a record (i.e., be recorded) in the database. A user record may include data indicating a unique user identity (e.g., such as a username, user identification number, etc.) of each user that has been assigned access to an application recorded in the database, and what level of access each user has been granted. That is, an application record may include a relation to a number of access control permissions (e.g., read, write, delete, etc.), a relation to a number of users that have access to the application, and a relation indicating what level or levels of access the user has. Such database relations or associations may map user identifiers to applicable permissions for various computer applications. An application management database may be any suitable database format, such as a relational database, a NoSQL database, a data warehouse, a data lake, etc.

In accordance with aspects, an application management database may additionally store a description of recorded access control levels associated with a given application. Access control descriptions may be in a natural language format. For instance, for an exemplary invoicing application with an “approval” access control, a description may be, “This role provides end users with the ability to approve submitted invoices.” Natural language descriptions may be particularly helpful when assessing custom access controls that are provided by various applications in use across an organization. Unlike the CRUD access control levels, customized access controls are not standardized or even readily recognizable by administrators or end users. Accordingly, customized access controls, including the combined scope of multiple users' access permissions, can be particularly difficult to understand and manage.

In accordance with aspects, natural language processing (NLP) techniques may be used, along with other machine learning (ML) models in order to classify access control levels and predict toxic combinations of assigned access control permissions in application groupings that may have business and/or process dependencies across platforms. By grouping applications that have business dependencies, modeling techniques may be concentrated on a smaller universe of access control permissions and, as a result, may perform more efficiently and produce more accurate results.

Accordingly, an organization's computer applications may be categorized into groups according to business area, business unit, and/or business process. Applications may be grouped into logical groups (also referred to herein as “audit groups”) based on information flows, data flows, business processes, etc. Such groups may cover all stages of information flows from source to consumption.

In accordance with aspects, applications that provide functionality for one or more steps in a multi-step business process may be included in an audit group for that business process. An exemplary business process may be an invoice approval process where an invoice is submitted in a first application and approved in a second application. Both the first and the second application may be included in an audit group, because the business process of invoice management includes steps performed by both the first application and the second application. As discussed above, an exemplary toxic access combination may include a user having both submit access to the first application and approval access to the second application.

In accordance with aspects, inclusion in one or more audit groups can be indicated and recorded in an application management database. For instance, an application record may include an association/relation to each audit group that an application is included in. Accordingly, when executing queries to retrieve application data for modeling (e.g., application metadata stored in an application management database, such as an access control description, as described herein), a query may specify all applications in a given audit group. An application reference may be stored in an application management database with a relation to each audit group that the corresponding application is a member of. A query of the database may retrieve all application references whose corresponding application belongs to a particular audit using, e.g., an audit group identifier as a lookup query parameter.

In accordance with aspects, an application management database may also be queried for application metadata, such as access control descriptions, and the returned data can be used in a ML modeling process to determine toxic access combinations. A database query may retrieve all application references that are related to an audit group, retrieve all user identifiers that have access control permissions to the applications associated with the returned application references, and further return all access control descriptions related to each access control permission of each user. The query may retrieve the noted data via relationships mapped among various tables in, e.g., a relational database. Textual data forming an access control permission description that is related to an access control of a referenced application may be processes with natural language processing (NLP) techniques to determine a role and a function unit based on part-of-speech (POS) tagging, dependency parsing and named entity recognition, and advanced models for context recognition.

In accordance with aspects, access control descriptions may be stored as descriptive sentence structures. These structures can include words or phrases that can be identified and tagged as included in predetermined keyword, or keyword group, classifications. Combinations of keyword and keyword group classifications may define a particular “role” of an access control. Examples of keyword and keyword group classifications include an access level designator and a functional unit designator.

Given the exemplary access control description, “This role provides end users with the ability to approve submitted invoices,” the word “approve” may be labeled as an access keyword. The phrase “submitted invoices” may be categorized as a functional unit. An access keyword may describe an access control permission level. For instance, “approve” indicates a level of access control in an invoice management process that is distinct from other access levels. Other access levels may include “view,” “submit,” “delete,” “pay,” etc. Other exemplary access-level keywords may correspond to the CRUD access permissions (i.e., create, read, update, delete). An identified functional unit describes an object within an application that an access control level may be granted with respect to. For example, a “submitted invoice” may be viewed, approved, deleted, paid, etc. Each classification may include one or more POS, such as one or more action keywords, one or more object keywords, etc.

In accordance with aspects, NLP models may be trained and used to identify parts of speech and classify identified parts of speech into keyword and keyword group classifications, including access classifications and functional unit classifications. NLP models may be trained to identify certain verbs (e.g., action words such as “perform,” “create,” “update,” “delete,” “approve,” “request,” “pay,” etc.) as access keywords. An NLP model may identify all verbs in an access control description through POS processing and, then, further evaluate all identified verbs to identify a root verb from which other parts of speech trace dependencies back to.

Dependency parsing may identify word dependencies starting with an identified root verb. Dependency parsing may be used in conjunction with POS tagging and contextual models (e.g., large language models) to classify words and phrases into keyword groups. Additionally, named entity recognition may identify organizational entities that are identified through modeling of access control descriptions. Exemplary named entities may include high-level sub-organizational entities such as “legal,” “human resources,” “technology,” etc.

In accordance with aspects, for each word in an access control description, modeling techniques may produce a POS tag, a dependency, an alphabet flag, a stop-word flag, a named entity recognition (NER) flag, a head text, a dependency explanation, and an array of dependency words.

In accordance with aspects, contextual-based models may be used to consider the similarity of access words in context. Contextual models may define the context for a root word, including the root words' dependencies on other parts of speech and then evaluate the alignment of context based on vectors created from the defined context. That is, a context defined by one or more words may be vectorized (i.e., a vector embedding may be generated) and a similarity measurement, such as cosine distance, may be used to determine alignment of context to other vectorized words and phrases. Access word similarity may be determined based on proximity in a multidimensional vector space (using. For instance, cosine distance). Words having vectorized contexts that are closer in a vector space can be determined to be closer in meaning than words whose vectorized contexts are further apart. Words having vectorized contexts that are determined to be within a predefine threshold window in a vector space may be determined to have the same meaning or a meaning that is substantially similar enough that the words indicate the same action within a similar context.

In accordance with aspects, cosine distance can be used to determine a closeness of the vectorized representations of the word contexts. Based on the determined cosine similarities, segregation duty groups may be generated. For instance, users having “view” access (or access that is determined to be contextually similar to, or the same as, view access by a modeling operation as discussed herein) for a given functional unit can be defined as one duty group. Another group may have “submit” access. “Approval” access may comprise a third duty group.

Duty group definitions or identifiers may be stored in an application management database and may be mapped via a database relationship to other duty groups. A mapped relationship between duty groups may indicate a toxic combination of access permissions. Duty groups may also be related to one or more audit groups. A toxic access control permission combination may be determined where a first duty group and a second duty group are both mapped to a same audit group, and are also mapped to a same user or user profile (via, e.g., database relational mapping). The mapping between duty groups may indicate a toxic combination of access permissions, and the mapping to the audit group may indicate the business process flow for which the combination is toxic. For example, given a user that is determined to have a permission (an assigned permission) that is related to or grouped in a “submit” duty group and a permission that is related to or grouped in an “approval” duty group, and where both the submit and approval duty groups are related to an audit group that represents an invoicing business process, the user may be determined to have a toxic combination of access control permissions for the invoicing business process and applications that support that business process.

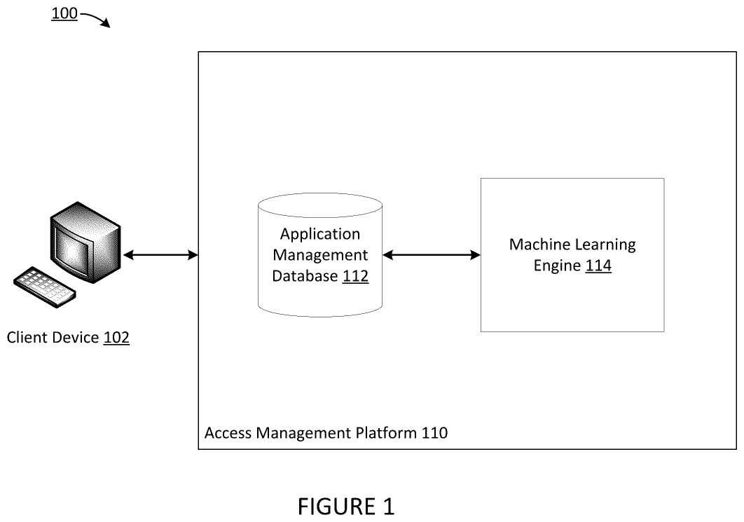

FIG. 1 depicts a block diagram of a system for detection of toxic access combinations, in accordance with aspects. System 100 includes access management platform 110 and client device 102. Access management platform 110 includes application management database 112 and machine learning engine 114. Application management database 112 may be configured to store application references that reference applications deployed and used by an implementing organization. Application management database may also be configured to store unique user identifiers that are associated with users of the stored applications. In some aspects, the a user identifier may be associated with a digital user profile of corresponding user. Application management database 112 may further be configured to store access permissions, and textual (e.g., natural language) descriptions thereof. Application references, user identifiers (and any associated user profiles), and access permission and descriptions thereof may be stored and interrelated in application management database 112 as described in more detail, herein.

Application management database 112 may further be configured to store definitions or representations of audit groups that are groupings of an implementing organization's deployed applications. An audit group may be formed through database relations that map computer application members of an audit group to each other. Audit groups may be defined by information flows, data flows, business processes, etc., as described in more detail, herein. Application management database 112 may further be configured to store duty groups, as described in more detail, herein.

In accordance with aspects, machine learning engine 114 may include NLP logic and/or models (e.g., machine learning models) for processing natural language text. Machine learning engine 114 may be in operative communication with application management database 112 and may be configured to execute queries against application management database 112. Machine learning engine 114 may retrieve, via a query of application management database 112, textual descriptions stored in application management database 112. Machine learning engine 114 may process the textual descriptions as described in more detail, herein. For example, machine learning engine 114 may be trained and/or configured to identify parts of speech and classify identified parts of speech into keyword and keyword group classifications. Classifications output by machine learning engine 114 may include associating access control permissions that are mapped to processed textual descriptions as an access level designator, a functional unit designator, etc., as described in more detail, herein.

In accordance with aspects, client device 102 may be configured for operative communication with access management platform 110. Client device 102 may be configured to execute, e.g., reporting software that queries application management database 112. Exemplary queries may be formatted to display toxic combinations of access control permissions as determined by the results of a query of application management database 112. For instance, client device 102 may format and execute a database query that returns all duty groups that are related to an audit group. The query may retrieve a list of users that have granted permissions to two or more related duty groups, where the duty group is related to one or more audit groups. Users that have such assigned permissions may be determined to have a toxic combination of access permissions to the audit group (and, therefore, to the business process, data flow, etc., that is represented by the audit group).

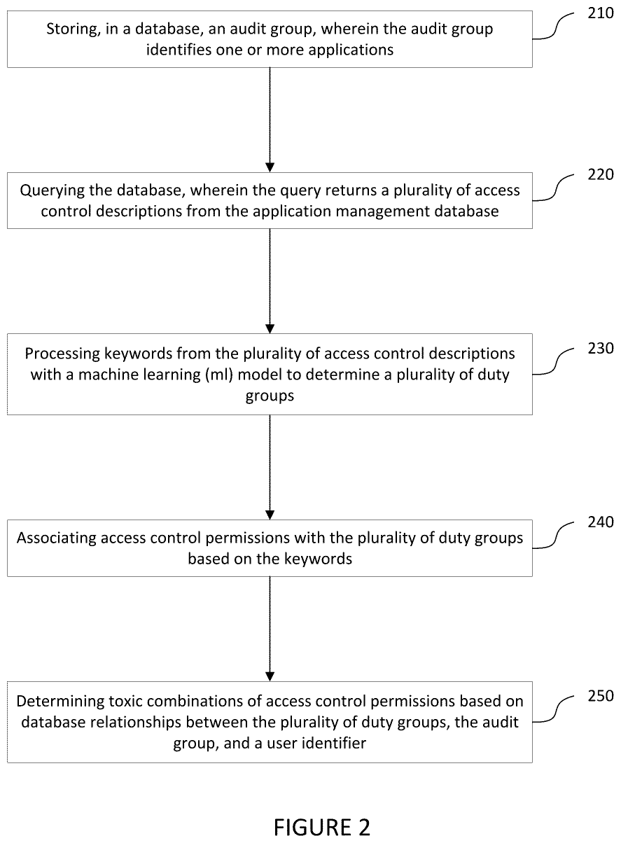

FIG. 2 depicts a logical flow for determining toxic access combinations, in accordance with aspects.

Step 210 includes storing, in a database, an audit group, wherein the audit group identifies one or more applications]

Step 220 includes querying the database, wherein the query returns a plurality of access control descriptions from the application management database]

Step 230 includes processing keywords from the plurality of access control descriptions with a machine learning (ML) model to determine a plurality of duty groups]

Step 240 includes associating access control permissions with the plurality of duty groups based on the keywords]

Step 250 includes determining toxic combinations of access control permissions based on database relationships between the plurality of duty groups, the audit group, and a user identifier]

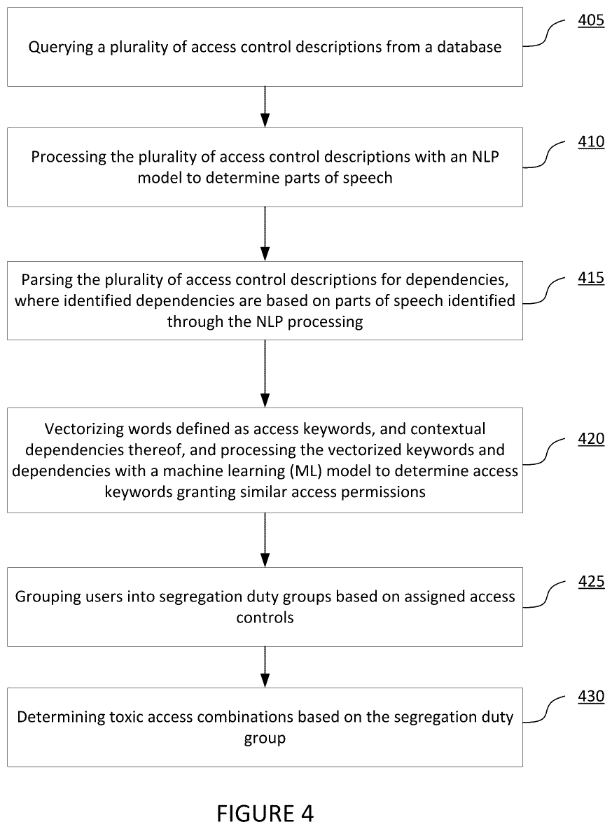

FIG. 4 depicts a logical flow for detection of toxic access combinations, in accordance with aspects.

At step 405, a plurality of access control descriptions are queried and returned from a database. The query may specify an audit group.

At step 410, the plurality of access control descriptions are processed with a natural language processing (NLP) model to determine parts of speech. The NLP model may identify all verbs in an access control description.

At step 415, the plurality of access control descriptions can be parsed for dependencies, where identified dependencies are based on parts of speech identified through the NLP processing.

At step 420, words defined as access keywords, and contextual dependencies can be vectorized and the vectorized keywords and dependencies can be processed with a machine learning (ML) model to determine access keywords granting similar access permissions.

At step 425, users can be grouped into segregation duty groups based on assigned access controls.

At step 430, toxic access combinations can be determined based on the segregation duty groups.

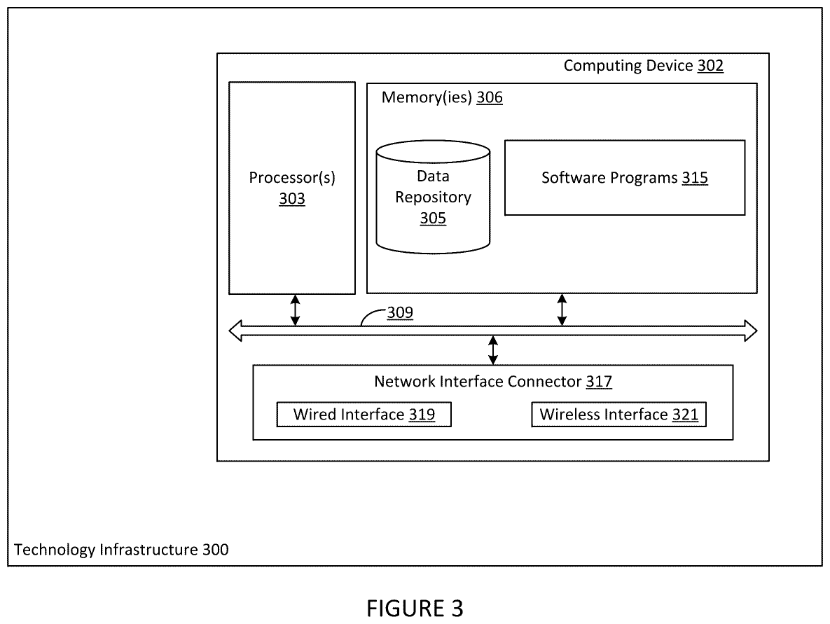

FIG. 3 depicts a block diagram of a technology infrastructure and computing device for implementing certain aspects of the present disclosure, in accordance with aspects. FIG. 3 includes technology infrastructure 300. Technology infrastructure 300 represents the technology infrastructure of an implementing organization. Technology infrastructure 300 may include hardware such as servers, client devices, and other computers or processing devices. Technology infrastructure 300 may include software (e.g., computer) applications that execute on computers and other processing devices. Technology infrastructure 300 may include computer network mediums, and computer networking hardware and software for providing operative communication between computers, processing devices, software applications, procedures and processes, and logical flows and steps, as described herein.

Exemplary hardware and software that may be implemented in combination where software (such as a computer application) executes on hardware. For instance, technology infrastructure 300 may include webservers, application servers, database servers and database engines, communication servers such as email servers and SMS servers, client devices, etc. The term “service” as used herein may include software that, when executed, receives client service requests and responds to client service requests with data and/or processing procedures. A software service may be a commercially available computer application or may be a custom-developed and/or proprietary computer application. A service may execute on a server. The term “server” may include hardware (e.g., a computer including a processor and a memory) that is configured to execute service software. A server may include an operating system optimized for executing services. A service may be a part of, included with, or tightly integrated with a server operating system. A server may include a network interface connection for interfacing with a computer network to facilitate operative communication between client devices and client software, and/or other servers and services that execute thereon.

Server hardware may be virtually allocated to a server operating system and/or service software through virtualization environments, such that the server operating system or service software shares hardware resources such as one or more processors, memories, system buses, network interfaces, or other physical hardware resources. A server operating system and/or service software may execute in virtualized hardware environments, such as virtualized operating system environments, application containers, or any other suitable method for hardware environment virtualization.

Technology infrastructure 300 may also include client devices. A client device may be a computer or other processing device including a processor and a memory that stores client computer software and is configured to execute client software. Client software is software configured for execution on a client device. Client software may be configured as a client of a service. For example, client software may make requests to one or more services for data and/or processing of data. Client software may receive data from, e.g., a service, and may execute additional processing, computations, or logical steps with the received data. Client software may be configured with a graphical user interface such that a user of a client device may interact with client computer software that executes thereon. An interface of client software may facilitate user interaction, such as data entry, data manipulation, etc., for a user of a client device.

A client device may be a mobile device, such as a smart phone, tablet computer, or laptop computer. A client device may also be a desktop computer, or any electronic device that is capable of storing and executing a computer application (e.g., a mobile application). A client device may include a network interface connector for interfacing with a public or private network and for operative communication with other devices, computers, servers, etc., on a public or private network.

Technology infrastructure 300 includes network routers, switches, and firewalls, which may comprise hardware, software, and/or firmware that facilitates transmission of data across a network medium. Routers, switches, and firewalls may include physical ports for accepting physical network medium (generally, a type of cable or wire—e.g., copper or fiber optic wire/cable) that forms a physical computer network. Routers, switches, and firewalls may also have “wireless” interfaces that facilitate data transmissions via radio waves. A computer network included in technology infrastructure 300 may include both wired and wireless components and interfaces and may interface with servers and other hardware via either wired or wireless communications. A computer network of technology infrastructure 300 may be a private network but may interface with a public network (such as the internet) to facilitate operative communication between computers executing on technology infrastructure 300 and computers executing outside of technology infrastructure 300.

FIG. 3 further depicts exemplary computing device 302. Computing device 302 depicts exemplary hardware that executes the logic that drives the various system components described herein. Servers and client devices may take the form of computing device 302. While shown as internal to technology infrastructure 300, computing device 302 may be external to technology infrastructure 300 and may be in operative communication with a computing device internal to technology infrastructure 300.

In accordance with aspects, system components such as an access management platform, a machine learning engine, client devices, servers, various database engines and database services, and other computer applications and logic may include, and/or execute on, components and configurations the same, or similar to, computing device 302.

Computing device 302 includes a processor 303 coupled to a memory 306. Memory 306 may include volatile memory and/or persistent memory. The processor 303 executes computer-executable program code stored in memory 306, such as software programs 315. Software programs 315 may include one or more of the logical steps disclosed herein as a programmatic instruction, which can be executed by processor 303. Memory 306 may also include data repository 305, which may be nonvolatile memory for data persistence. The processor 303 and the memory 306 may be coupled by a bus 309. In some examples, the bus 309 may also be coupled to one or more network interface connectors 317, such as wired network interface 319, and/or wireless network interface 321. Computing device 302 may also have user interface components, such as a screen for displaying graphical user interfaces and receiving input from the user, a mouse, a keyboard and/or other input/output components (not shown).

In accordance with aspects, services, modules, engines, etc., described herein may provide one or more application programming interfaces (APIs) in order to facilitate communication with related/provided computer applications and/or among various public or partner technology infrastructures, data centers, or the like. APIs may publish various methods and expose the methods, e.g., via API gateways. A published API method may be called by an application that is authorized to access the published API method. API methods may take data as one or more parameters or arguments of the called method. In some aspects, API access may be governed by an API gateway associated with a corresponding API. In some aspects, incoming API method calls may be routed to an API gateway and the API gateway may forward the method calls to internal services/modules/engines that publish the API and its associated methods.

A service/module/engine that publishes an API may execute a called API method, perform processing on any data received as parameters of the called method, and send a return communication to the method caller (e.g., via an API gateway). A return communication may also include data based on the called method, the method's data parameters and any performed processing associated with the called method.

API gateways may be public or private gateways. A public API gateway may accept method calls from any source without first authenticating or validating the calling source. A private API gateway may require a source to authenticate or validate itself via an authentication or validation service before access to published API methods is granted. APIs may be exposed via dedicated and private communication channels such as private computer networks or may be exposed via public communication channels such as a public computer network (e.g., the internet). APIs, as discussed herein, may be based on any suitable API architecture. Exemplary API architectures and/or protocols include SOAP (Simple Object Access Protocol), XML-RPC, REST (Representational State Transfer), or the like.

The various processing steps, logical steps, and/or data flows depicted in the figures and described in greater detail herein may be accomplished using some or all of the system components also described herein. In some implementations, the described logical steps or flows may be performed in different sequences and various steps may be omitted. Additional steps may be performed along with some, or all of the steps shown in the depicted logical flow diagrams. Some steps may be performed simultaneously. Some steps may be performed using different system components. Accordingly, the logical flows illustrated in the figures and described in greater detail herein are meant to be exemplary and, as such, should not be viewed as limiting. These logical flows may be implemented in the form of executable instructions stored on a machine-readable storage medium and executed by a processor and/or in the form of statically or dynamically programmed electronic circuitry.

The system of the invention or portions of the system of the invention may be in the form of a “processing device,” a “computing device,” a “computer,” an “electronic device,” a “mobile device,” a “client device,” a “server,” etc. As used herein, these terms (unless otherwise specified) are to be understood to include at least one processor that uses at least one memory. The at least one memory may store a set of instructions. The instructions may be either permanently or temporarily stored in the memory or memories of the processing device. The processor executes the instructions that are stored in the memory or memories in order to process data. A set of instructions may include various instructions that perform a particular step, steps, task, or tasks, such as those steps/tasks described above, including any logical steps or logical flows described above. Such a set of instructions for performing a particular task may be characterized herein as an application, computer application, program, software program, service, or simply as “software.” In one aspect, a processing device may be or include a specialized processor. As used herein (unless otherwise indicated), the terms “module,” and “engine” refer to a computer application that executes on hardware such as a server, a client device, etc. A module or engine may be a service.

As noted above, the processing device executes the instructions that are stored in the memory or memories to process data. This processing of data may be in response to commands by a user or users of the processing device, in response to previous processing, in response to a request by another processing device and/or any other input, for example. The processing device used to implement the invention may utilize a suitable operating system, and instructions may come directly or indirectly from the operating system.

The processing device used to implement the invention may be a general-purpose computer. However, the processing device described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices that is capable of implementing the steps of the processes of the invention.

It is appreciated that in order to practice the method of the invention as described above, it is not necessary that the processors and/or the memories of the processing device be physically located in the same geographical place. That is, each of the processors and the memories used by the processing device may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above may, in accordance with a further aspect of the invention, be performed by a single component. Further, the processing performed by one distinct component as described above may be performed by two distinct components. In a similar manner, the memory storage performed by two distinct memory portions as described above may, in accordance with a further aspect of the invention, be performed by a single memory portion. Further, the memory storage performed by one distinct memory portion as described above may be performed by two memory portions.

Further, various technologies may be used to provide communication between the various processors and/or memories, as well as to allow the processors and/or the memories of the invention to communicate with any other entity, i.e., so as to obtain further instructions or to access and use remote memory stores, for example. Such technologies used to provide such communication might include a network, the Internet, Intranet, Extranet, LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of the invention. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing device what to do with the data being processed.

Further, it is appreciated that the instructions or set of instructions used in the implementation and operation of the invention may be in a suitable form such that the processing device may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing device, i.e., to a particular type of computer, for example. The computer understands the machine language.

Any suitable programming language may be used in accordance with the various aspects of the invention. Illustratively, the programming language used may include assembly language, Ada, APL, Basic, C, C++, COBOL, dBase, Forth, Fortran, Java, Modula-2, Pascal, Prolog, REXX, Visual Basic, and/or JavaScript, for example. Further, it is not necessary that a single type of instruction or single programming language be utilized in conjunction with the operation of the system and method of the invention. Rather, any number of different programming languages may be utilized as is necessary and/or desirable.

Also, the instructions and/or data used in the practice of the invention may utilize any compression or encryption technique or algorithm, as may be desired. An encryption module might be used to encrypt data. Further, files or other data may be decrypted using a suitable decryption module, for example.

As described above, the invention may illustratively be embodied in the form of a processing device, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing device, utilized to hold the set of instructions and/or the data used in the invention may take on any of a variety of physical forms or transmissions, for example. Illustratively, the medium may be in the form of a compact disk, a DVD, an integrated circuit, a hard disk, a floppy disk, an optical disk, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by a processor.

Further, the memory or memories used in the processing device that implements the invention may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the invention, a variety of “user interfaces” may be utilized to allow a user to interface with the processing device or machines that are used to implement the invention. As used herein, a user interface includes any hardware, software, or combination of hardware and software used by the processing device that allows a user to interact with the processing device. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing device as it processes a set of instructions and/or provides the processing device with information. Accordingly, the user interface is any device that provides communication between a user and a processing device. The information provided by the user to the processing device through the user interface may be in the form of a command, a selection of data, or some other input, for example.

As discussed above, a user interface is utilized by the processing device that performs a set of instructions such that the processing device processes data for a user. The user interface is typically used by the processing device for interacting with a user either to convey information or receive information from the user. However, it should be appreciated that in accordance with some aspects of the system and method of the invention, it is not necessary that a human user actually interact with a user interface used by the processing device of the invention. Rather, it is also contemplated that the user interface of the invention might interact, i.e., convey and receive information, with another processing device, rather than a human user. Accordingly, the other processing device might be characterized as a user. Further, it is contemplated that a user interface utilized in the system and method of the invention may interact partially with another processing device or processing devices, while also interacting partially with a human user.

It will be readily understood by those persons skilled in the art that the present invention is susceptible to broad utility and application. Many aspects and adaptations of the present invention other than those herein described, as well as many variations, modifications, and equivalent arrangements, will be apparent from or reasonably suggested by the present invention and foregoing description thereof, without departing from the substance or scope of the invention.

Accordingly, while the present invention has been described here in detail in relation to its exemplary aspects, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such aspects, adaptations, variations, modifications, or equivalent arrangements.

1. A method comprising:
storing, in an application management database, an audit group, wherein the audit group identifies one or more computer applications;
querying the application management database, wherein the querying returns a plurality of access control descriptions from the application management database;
processing keywords from the plurality of access control descriptions with a machine learning (ML) model to determine a plurality of duty groups;
associating access control permissions with the plurality of duty groups based on the keywords; and
determining toxic combinations of the access control permissions based on database relationships between the plurality of duty groups, the audit group, and a user identifier.

2. The method of claim 1, wherein the audit group includes a plurality of computer applications.

3. The method of claim 2, wherein the plurality of computer applications are included in an organizational process.

4. The method of claim 1, comprising:
parsing the plurality of access control descriptions for dependencies.

5. The method of claim 4, comprising:
determining parts of speech in the plurality of access control descriptions using a natural language processing (NLP) model.

6. The method of claim 5, wherein the dependencies are based on the parts of speech.

7. The method of claim 6, comprising:
generating vector embeddings from the keywords.

8. A system comprising at least one computer including a processor and a memory, wherein the at least one computer is configured to:
store, in an application management database, an audit group, wherein the audit group identifies one or more computer applications;
query the application management database, wherein the querying returns a plurality of access control descriptions from the application management database;
process keywords from the plurality of access control descriptions with a machine learning (ML) model to determine a plurality of duty groups;
associate access control permissions with the plurality of duty groups based on the keywords; and
determine toxic combinations of the access control permissions based on database relationships between the plurality of duty groups, the audit group, and a user identifier.

9. The system of claim 8, wherein the audit group includes a plurality of computer applications.

10. The system of claim 9, wherein the plurality of computer applications are included in an organizational process.

11. The system of claim 8, comprising:
parsing the plurality of access control descriptions for dependencies.

12. The system of claim 11, comprising:
determining parts of speech in the plurality of access control descriptions using a natural language processing (NLP) model.

13. The system of claim 12, wherein the dependencies are based on the parts of speech.

14. The system of claim 13, comprising:
generating vector embeddings from the keywords.

15. A non-transitory computer readable storage medium, including instructions stored thereon, which instructions, when read and executed by one or more computer processors, cause the one or more computer processors to perform steps comprising:
storing, in an application management database, an audit group, wherein the audit group identifies one or more computer applications;
querying the application management database, wherein the querying returns a plurality of access control descriptions from the application management database;
processing keywords from the plurality of access control descriptions with a machine learning (ML) model to determine a plurality of duty groups;
associating access control permissions with the plurality of duty groups based on the keywords; and
determining toxic combinations of the access control permissions based on database relationships between the plurality of duty groups, the audit group, and a user identifier.

16. The non-transitory computer readable storage medium of claim 15, wherein the audit group includes a plurality of computer applications.

17. The non-transitory computer readable storage medium of claim 16, wherein the plurality of computer applications are included in an organizational process.

18. The non-transitory computer readable storage medium of claim 15, comprising:
parsing the plurality of access control descriptions for dependencies.

19. The non-transitory computer readable storage medium of claim 18, comprising:
determining parts of speech in the plurality of access control descriptions using a natural language processing (NLP) model.

20. The non-transitory computer readable storage medium of claim 19, wherein the dependencies are based on the parts of speech and comprising:
generating vector embeddings from the keywords.
